(19) United States
(12) Patent Application Publication
(10) Pub. No.: US 2006/0153953 A1
(43) Pub. Date: Jul. 13, 2006

(54) Method and device for producing a seamless edible cellulose casing

(76) Inventors: Herbert Gord, Ingelheim (DE); Klaus-Dieter Hammer, Mainz (DE); Rainer Neeff, Wiesbaden (DE); Klaus Berghof, Rudolstadt-Schwarza (DE); Markus Eilers, Wietmarschen-Lohne (DE); Eberhard Taeger, Weissbach (DE)

Correspondence Address: Cathy R Moore;ProPat, 425 C South Sharon Amity Road, Charlotte, NC, 28211, US

(21) Appl. No.: 10/563,200

(22) PCT Filed: Jun. 30, 2004
(86) PCT No.: PCT/EP04/07084

§ 371 Date: Jan. 3, 2006

(30) Foreign Application Priority Data
Jul. 4, 2003 (DE) 103 30 292.1

(51) Int. Cl. A22C 13/00

(52) U.S. Cl. 426/140

(57) ABSTRACT

For production of a seamless edible cellulose tubing from underivatized cellulose, a solution of the underivatized cellulose in tertiary amine N-oxide, of additives and water, is extruded as tubing from an annular die and conducted through an air gap into a water bath. The cellulose tubing is conducted out of the water bath, cleaned by spraying with heated water and thereafter passed through at least two wash sections and a plasticizing section. After exit from the plasticizing section, the wet cellulose tubing is predried in the laid-flat state, before it is dried to its final moisture. The predryer 13 is arranged vertically or horizontally and consists of an insulated tube to which is fed air heated by a heat exchanger in an accurately metered amount and at a constant temperature of up to 130° C. The main dryer 19 is arranged horizontally and contains tangentially and radially directed air nozzles, the air jets of which keep the inflated cellulose tubing 20 suspended during the drying operation.

The invention relates to a method for producing a seamless edible cellulose tubing from underivatized cellulose in which a solution of the underivatized cellulose in tertiary amine N-oxide, additives and water is extruded from an annular die as tubing and conducted downward through an air gap into a water bath, in order to solidify the cellulose and allow amine N-oxide to escape from the cellulose, in addition, the cellulose tubing is conducted out of the water bath, and relates to a method for producing such a cellulose tubing.

EPA 0 899 076 discloses a method and a device for producing a seamless cellulose-based film tubing by extruding an aqueous cellulose N-methylmorpholine N-oxide (NMMO) solution through an annular die into a spinning vat in which is situated a spinning bath. To avoid adhesions on the inside, the tubing is kept in cylindrical shape by maintaining a gas internal pressure and also by introducing water. The tubing can in this manner be turned over a roller near the bottom of the spinning bath vessel and taken off upward. On the take-off roll, the tubing is laid flat and fed to a cleaning process. It is necessary in this case to remove the mixture of NMMO and water collecting in the tube interior. This is performed by treating the tubing with aqueous baths of different temperature and composition, with which the tubing is contacted in the countercurrent flow principle. At the end of a treatment section, the inside of the tubing is freed from liquid impurities still present by diffusion processes. The completion of the wet treatment is formed by an immersion bath which contains an aqueous solution of glycerol. By a suitable concentration and residence time, the tubing is plasticized in a targeted manner, by it taking up a defined glycerol content, the exact maintenance of the glycerol content being essential for the later problem-free processing of the tubing. After the tubing has left the plasticizing stage, generally, in the tubing interior, a mixture of entrained water and glycerol has formed. This mixture collects in the tubing interior on the pinching-off before the drying operation, as a result of which the drying process is delayed and the mechanical properties of the tubing with respect to extensibility and strength are impaired.

WO03/000060 A1 discloses a cellulose-containing edible or chewable tubing which is produced by the NMMO method. This tubing, in addition to cellulose, further contains at least one dissolved protein and at least one undissolved filler. To produce an edible or chewable tubing casing, the cellulose and the possibly precrosslinked protein are dissolved in aqueous NMMO, the solution is mixed with a filler, and the resultant suspension is extruded. The suspension, to produce seamless tubing casings, is extruded through an annular die. The individual method steps substantially correspond to the method according to the abovementioned EP-A 0 899 076.

The protein is preferably a natural globular protein, in particular casein (milk protein), soyprotein, gluten (wheat protein), zein (corn protein), ardein (peanut protein) or pea protein. In principle, any protein is suitable which is soluble together with the cellulose in NMMO monohydrate. The weight fraction of the at least one protein is generally 5 to 50% by weight, preferably 8 to 45% by weight, in each case based on the dry weight of the tubing casing, i.e. the weight of the water-free and glycerol-free tubing casing. In order to decrease or eliminate the water solubility of the protein, it is expedient to crosslink the protein in advance. This may be achieved, for example, by reacting the protein with an aldehyde, with methylol, epoxide and/or enzyme. The terms “aldehyde”, “methylol” etc. comprise here compounds having more than one carbaldehyde or methylol group.

Thus dimethylol ethyleneurea and dialdehydes, in particular glyoxal, malonaldehyde, succinaldehyde and glutaraldehyde, are particularly suitable crosslinkers. The crosslinking is customarily performed in the presence of Lewis acids; the temperature in the reaction is generally from 0 to 160° C. In the crosslinking, not only the free amino groups and the acid amide groups, where present, of the protein react, but also the imino groups of the peptide bonds and the hydroxyl groups of the serine. An enzyme having crosslinking activity is, for example, transglutaminase. The weight fraction of crosslinker(s) is dependent on its type. In general, it is 0.5 to 5.0% by weight, preferably 1.0 to 3.0% by weight, in each case based on the weight of the protein.

Crosslinking can also be performed subsequently. For example, in the last vat, a toxicologically safe crosslinking agent can be applied to the tubular casing together with the secondary plasticizer, this is generally glycerol. Preferred crosslinking agents are citral, tannin, sugar dialdehyde, dialdehyde starch, caramel and epoxidized linseed oil. The amount applied is controlled in such a manner that the tubular casing then contains about 0.5 to 5% by weight, based on its dry weight, of crosslinking agent. The actual crosslinking then proceeds on the subsequent drying and on storage of the tubular casing.

The fillers are to dissolve as little as possible in the NMMO spinning solution. Fillers insoluble in NMMO can already be added to the solution before water is distilled off under reduced pressure. Fillers which have a certain solubility in NMMO are expediently not mixed with the spinning solution until immediately before the extrusion. If necessary, the solubility of the fillers in NMMO monohydrate can be reduced by precrosslinking. Like the proteins, the fillers interrupt the structure of the cellulose. The extensibility in the transverse direction is sometimes considerably increased and the strength (breaking stress, bursting pressure) reduced. Particularly suitable organic fillers are bran, in particular wheat bran, milled natural fibers, in particular milled flax, hemp or cotton fibers, cotton linters, chitosan, guar seed meal, carob bean meal, or microcrystalline cellulose. Instead of the organic fillers, or additionally thereto, finely divided inorganic fillers can also be used. Examples of these are ground calcium carbonate or pulverulent SiO₂. The weight fraction of filler(s) is generally 3 to 60% by weight, preferably 4 to 50% by weight, in each case based on the dry weight of the tubular casing.

In order to be readily chewable, the tubular casing must only have low wet strength and also must not be very tough. By means of the addition of hydrophilic additives, the chewability can be further improved. The hydrophilic additives are likewise soluble in the NMMO spinning solution. Particularly suitable additives are homopolysaccharides and derivatives thereof (in particular esters and ethers), such as starch, starch acetate, chitin, chitosan or pectin; heteropolysaccharides and derivatives thereof, such as carrageenan, xanthan, alginic acid and alginates; finally, also toxicologically safe synthetic polymers or copolymers, such as polyvinylpyrrolidone, poly(vinyl alcohol) or poly(ethylene oxide)s. The weight fraction of the hydrophilic additives is generally about 0.5 to 15% by weight, preferably 1 to 10% by weight, in each case based on the total weight of the tubular casing.

The tubular casing can be still further modified using primary plasticizers or lubricants. These are, for example, triglycerides, waxes, such as shellac, hydrocarbons, such as edible natural rubbers, or paraffins.

Expediently, the tubular casing also contains a secondary plasticizer, in particular glycerol. The secondary plasticizer is added, as is generally customary, in a plasticizer vat immediately before drying of the tubular casing.

DE 44 21 482 C2 discloses a method for producing oriented cellulose films by spinning underivatized cellulose dissolved in amine oxides through an annular die into a precipitation bath. In this case, the cellulose solution is extruded through the annular die and an outer air gap downward into the precipitation bath, the film tubing being blown using a propellent gas, in particular air. The cellulose film can be used as biodegradable and compostable material having a broad field of use, for example as packaging material such as packaging films, pouches or sausage casings.

EP-B 0 662 283 describes a method for producing food casings from underivatized cellulose. In this case, a solution containing underivatized cellulose, tertiary amine N-oxide and water is extruded at a temperature below 116° C. through a casting gap downward to form an extruded tubing which, before entry into a water bath, is conducted through an air section. In the water bath the cellulose is solidified and amine oxide is removed from the extruded tubing. The extruded tubing exits from the water bath as wet tubing, is blown and dried in order to form a cellulose tubing. The tertiary amine N-oxide is N-methylmorpholine N-oxide.

It is an object of the invention to stabilize the water-containing tubular casing after exit from the wash zones and the plasticizing zone before the final drying sufficiently to increase the tubing strength, maintain the caliber constancy and to make the course of the pressure-extension curve flatter.

This object is achieved by a method of the type described at the outset in such a manner that it comprises cleaning the cellulose tubing by spraying with heated water, the cellulose tubing being transported upward at an incline during the spraying, thereafter the tubing is passed through at least two wash sections and one plasticizing section and after exit from the plasticizing section is predried as wet tubing in the laid-flat state before it is dried, in the blown state, to its final moisture. In this way, according to the method, the cellulose tubing is predried to a moisture of 30 to 70% of the moisture of the wet tubing. In particular, the cellulose tubing is predried to a moisture of 40 to 60% of the moisture of the wet tubing.

In a further embodiment of the method, an impregnation solution is applied to the tube interior of the predried tubing. The predrying shrinks the tubing and decreases its extensibility.

When the inventive method is carried out, the cellulose tubing passes through a predrying zone at least two times by being turned round by 180° at one end of the predrying zone.

The further embodiment of the method results from claims 7 to 11.

A device for producing a seamless edible cellulose tubing from underivatized cellulose which is extruded from an annular die and introduced via an air gap into a water bath, turned round in this and conducted out, conducted via a conveyor belt through a first and second wash section into a plasticizing section, is distinguished in that the cellulose tubing, upstream of the plasticizing section, is transportable into a predryer which is provided upstream of a main dryer and the predryer is arranged vertically or horizontally. Expediently, the predryer has a length of up to 12 m.

In an embodiment of the device, close to an exit orifice of the predryer, there is arranged a guide roll round which the cellulose tubing runs after passing through the predryer and, turned round through 180°, passes the predryer a further time and leaves via an exit orifice.

Further embodiment features of the device follow from patent claims 15 to 21.

The invention achieves the advantage that the majority of the internal liquid present in the non-inflated, laid-flat state of the tubing is removed from the tubing after exiting the plasticizing section, i.e. the glycerol bath, by the predrying. As a result, the tubing material can shrink in the transverse direction free from the influence of internal liquid, as a result of which the mechanical properties, in particular the tubing strength, are increased, and, furthermore, the pressure-extension curve is flattened, so that the tubing material, compared with a non-predried material, has an up to 30% higher bursting pressure.

The device as claimed in the invention will be described in more detail with reference to the drawings. In the drawings:

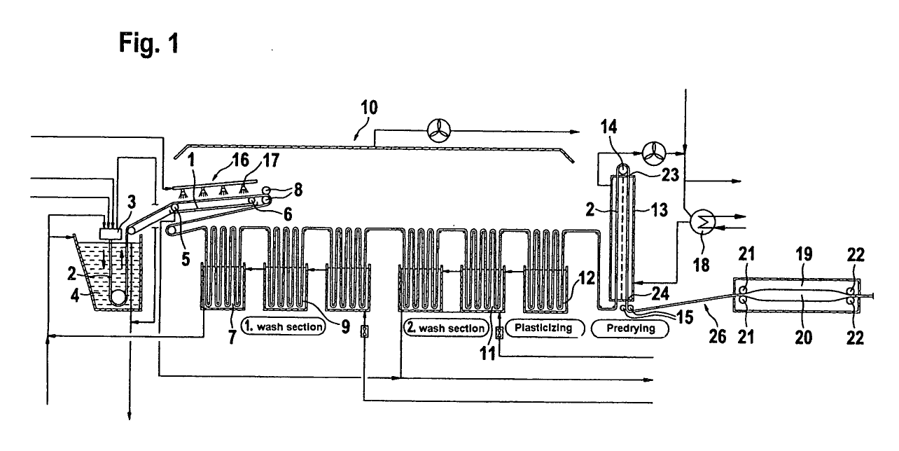

FIG. 1 shows an outline diagram of the treatment sections of a tubing made of underivatized cellulose.

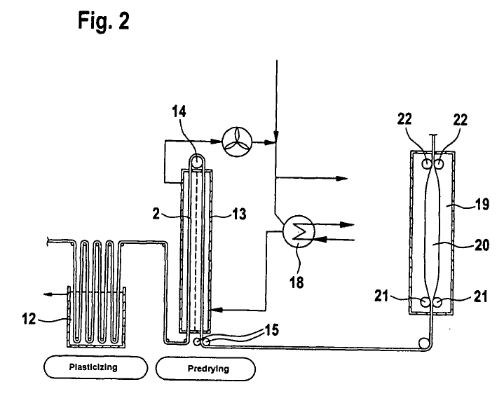

FIG. 2, in a section of FIG. 1, shows a plasticizing section, a vertical predryer and a main dryer, and

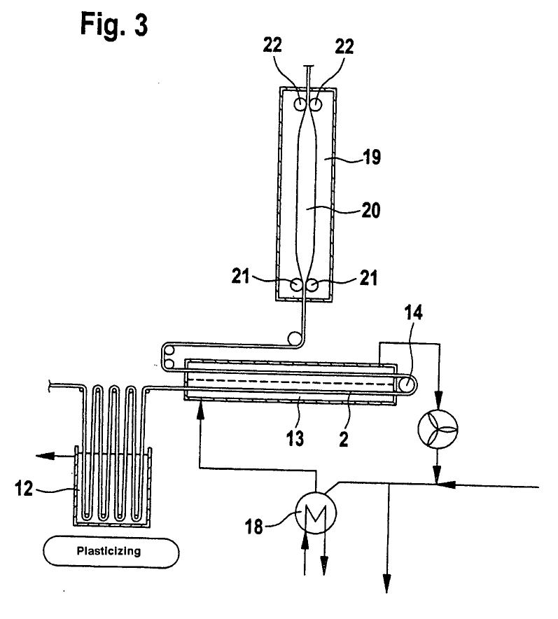

FIG. 3 shows an embodiment modified with respect to FIG. 1, having one horizontal predryer and the main dryer.

As shown in FIG. 1, a seamless edible cellulose tubing 2 made of underivatized cellulose is extruded from an annular die 3 and introduced via an air gap into a water bath 4. The cellulose tubing 2 is turned round in the water bath close to the bottom and conducted out of the water bath and conducted via a conveyor belt 1 which is inclined obliquely upward, through a first wash section 9 which, for example, consists of three wash vats, and a second wash section 11 of two wash vats, into a plasticizing section 12. Above the conveyor belt 1 is situated a spray device 16 having spray nozzles 17 through which the cellulose tubing is sprayed with heated water and cleaned. At the top end of the conveyor belt 1 is situated a pinch and guide roll pair 6, 8, through which the cellulose tubing is conducted and turned round obliquely downward in the direction of the first wash section.

After exiting the plasticizing section 12 which consists of a glycerol vat which contains a mixture of water and glycerol, the laid-flat cellulose tubing is turned round upward by 90° without pinching. The liquid adhering to its outside can be retained or scraped off by suitable scrapers which are not shown. A vertical arrangement of a predryer 13 has proved to be space-saving and efficient. The predryer consists of a drying tube, at the top end of which is mounted a guide roll 14 around which the cellulose tubing 2, turned round by 180°, is conducted vertically downward through the predryer 13, i.e. passes a further time through the predryer 13. The drying tube is an insulated tube to which is fed air heated by the heat exchanger in an accurately metered amount and constant temperature of up to 130° C. The vertical arrangement of the predryer 13 gives a natural backflow of the solution present in the tube interior of the cellulose tubing 2, the amount of liquid to be removed being uniformly distributed over the tubing periphery. The vertical arrangement of the predryer 13 keeps the space requirement within the production plant as low as possible. The predryer 13, in the case of a horizontal design, can have a length of up to 12 m. The guide roll 14 is arranged close to an upper exit orifice 23 of the predryer. After the cellulose tubing 2 is turned round by 180° by the guide roll 14 and has passed the predryer 13 a second time, it exits via a lower entry orifice 24 and passes through a roll pair 15. One of the rolls of the roll pair 15 turns the cellulose tubing round by somewhat more than 90° in the direction of a horizontally arranged main dryer 19. At a position marked by the arrow 26, an impregnation can be introduced into the interior of the cellulose tubing 2 before its entry into the main dryer 19. For this purpose, the transport of the predried cellulose tubing is interrupted from time to time to introduce the impregnation solution into the tubing. By means of the impregnation, different additional effects can be achieved, such as improved sausage emulsion adhesion, or alternatively easier peelability of the tubing casing from the sausage emulsion, presmoking of the tubing casing by a liquid aroma and a hydrophobization of the tubing casing in order to delay water uptake during the stuffing process with the sausage emulsion. As a result of the predrying with partially completed removal of water, the uptake capacity of the tubing for the impregnation solution or liquid is greater than without predrying. The low water content in the tubing has the effect that the concentration of the impregnation solution remains constant for longer, so that interruptions of the tubing transport to correct the impregnation become rare. Furthermore, predrying in the laid-flat state of the tubing avoids having to interrupt the tubing transport as soon as after exit of the tubing from the plasticizing section in order to remove liquid in the interior of the tubing. As a result, the labor requirement and also the waste of tubing material, since the tube must be divided on each interruption, are decreased. Furthermore, as a result of the predrying, no liquid collects upstream of a pinch-roll pair 21 of the main dryer 19. Without predrying, customarily, such a liquid collection occurs, so that continuous transport of the tubing must be stopped in order to remove the liquid accumulation by opening the tubing. The tubing 2 which is slightly shrunk in the predryer 13 with respect to its cross section has a lower extensibility than before the predrying. This leads to the fact that on inflating the laid-flat tubing, which takes place during the main drying operation before the end of the main dryer, no so strong deformation of the tubing piece which is situated directly downstream of the pinch-roll pair 21 after entry into the main dryer takes place. As a result, short-term oversize caliber of the inflated tubing 20 is avoided. Since, as a result of the predrying, the extensibility of the inflated tubing 20 in the main dryer 19 is overall lower than without predrying, for inflating the tubing a higher air pressure can be employed, since the overall stability of the tubing has been increased by the predrying. The bursting pressure of the predried tubing is around up to 30% higher than that of a non-predried tubing. As a result of the higher air pressure, a greater drawing of the tubing 20 in the transverse direction takes place, and thus a flattening of its extensibility curve, so that a very constant caliber can be maintained when stuffing the tubing with sausage emulsion. The main dryer 19 contains tangentially and radially directed air nozzles, the air jets of which keep the inflated cellulose tubing 20 suspended during the drying operation.

In the predryer 13, heated air is blown into the laid-flat cellulose tubing 2. The air which is blown in is heated to a temperature up to 130° C. In the main dryer 19, the laid-flat cellulose tubing 2 is inflated with heated air between the two pinch-roll pairs 21, 22 to form the tubular cellulose tubing 20. The tubular cellulose tubing 20 is dried in the inflated state to its final moisture of up to 10% of the moisture of the wet cellulose tubing, and shrunk to its final caliber.

FIG. 3 shows a further embodiment of the device in which the predryer 13 is arranged horizontally. The cellulose tubing 2 exiting from the plasticizing section 12 is turned round horizontally and introduced into the predryer 13. At the right-hand end of the predryer 13, is situated the guide roll 14 round which the cellulose tubing 2 is turned by 180° and passes a second time through the predryer 13 and exits at the left-hand end horizontally. Thereafter, the cellulose tubing 2 is turned round two rolls by 180° and passes to a further guide roll, around which it is conducted, turned round by 90°, vertically upward through the main dryer 19. In the main dryer 19 are situated two pinch-roll pairs 21 and 22, between which the cellulose tubing is inflated by air to form the tubular cellulose tubing 20.

The invention will be described in more detail with reference to the exemplary embodiments described hereinafter.

### EXAMPLE 1

An edible cellulose tubing produced by the above-described NMMO method made of underivatized cellulose is conducted, downstream of the cleaning process, through a bath of aqueous glycerol solution. The concentration of the glycerol solution and the time of passage of the cellulose tubing through the glycerol bath are such that the glycerol content in the cellulose tubing 20 after the final drying is up to 18%.

Downstream of the glycerol bath, the cellulose tubing 2 is turned round into the vertically arranged predryer 13. The length of the predryer 13 is up to 10 m. The temperature of the air which is blown in in the predryer is controlled to 120° C. The length of the predryer 13 and the transport velocity of the cellulose tubing 2 are matched to one another in such a way that the moisture of the cellulose tubing 2 at the exit 24 of the predryer 13 is 50%, based on the wet cellulose tubing. Thereafter, the predried cellulose tubing 2 is fed to the main dryer 19 and there, between the two pinch-roll pairs 21, 22, is brought in the inflated state using hot air to a final moisture of up to 10%, again based on the wet cellulose tubing. By means of the air pressure in the tube interior when the inflated cellulose tubing 20 is situated in the main dryer 19, the final caliber of the cellulose tubing 20 is established. The bursting pressure and the extensibility curve of the tubing material are monitored and serve for internal production control as specified in DIN ISO 9002. Since the pressure-extensibility curve of the predried tubing is flatter than that of a wet tubing, a bursting pressure higher by 30% compared with a non-predried tubing is achieved.

### EXAMPLE 2

A cellulose tubing 2 produced and predried as in the application case of example 1 is finished with an internal impregnation upstream of the passage through the feed pinch-roll pair 21 of the main dryer 20. The moisture of the predried cellulose tubing 2 is set at 60%, based on the wet cellulose tubing. The impregnation active compound is, in an aqueous solution, charged into the interior of the cellulose tubing, the impregnation solution being taken up significantly more uniformly on the inside of the cellulose tubing and in the case of a non-predried cellulose tubing. Furthermore, the concentration of the impregnation solution present in the cellulose tubing remains constant for significantly longer than would be the case without predrying. This leads to longer tubing pieces or tubing sections without replenishment interruptions of the tubing transport and thus to low labor expenditure and less waste of tubing material.

### EXAMPLE 3

A cellulose tubing 2 produced and predried according to example 1 is impregnated with an aqueous solution which contains 2% by weight of a distearyl diketene. This preparation leads to a delayed water uptake during the later stuffing process with sausage emulsion and to an improved caliber constancy of the cellulose tubing 20.

The aqueous impregnation solution having 2% by weight of a distearyl diketene is generally used in the impregnation of cellulose tubings and is neither restricted to example 3 nor to examples 1 and 2.

1. A method for producing a seamless edible cellulose tubing from underivatized cellulose in which a solution of the underivatized cellulose in tertiary amine N-oxide, additives and water is extruded from an annular die as tubing and conducted downward through an air gap into a water bath, in order to solidify the cellulose and the additives and allow amine N-oxide to escape from the cellulose, in addition, the cellulose tubing is conducted out of the water bath, which comprises cleaning the cellulose tubing by spraying with heated water, the cellulose tubing being transported upward at an incline during the spraying, thereafter the tubing is passed through at least two wash sections and one plasticizing section and after exit from the plasticizing section is predried as wet tubing in the laid-flat state before it is dried, in the blown state, to its final moisture.

2. The method as claimed in claim 1, wherein the cellulose tubing is predried to a moisture of about 30 to about 70% of the moisture of the wet tubing.

3. The method as claimed in claim 2, wherein the cellulose tubing is predried to a moisture of about 40 to about 60% of the moisture of the wet tubing.

4. The method as claimed in claim 1 or 2, wherein an impregnation solution is applied to the tubing inside of the predried tubing.

5. The method as claimed in claim 1, wherein the tubing is shrunk by the predrying and its extensibility is decreased.

6. The method as claimed in claim 1, wherein the cellulose tubing passes through a predrying zone two times, by being turned round by 180° at one end of the predrying zone.

7. The method as claimed in claim 6, wherein the cellulose tubing passes vertically through the predrying zone.

8. The method as claimed in claim 6, wherein the cellulose tubing passes horizontally through the predrying zone.

9. The method as claimed in claim 1, wherein the predrying takes place in a predrying zone of a length of up to about 12 m and is predried by air which is at a temperature up to about 130° C.

10. The method as claimed in claim 9, wherein the running speed of the cellulose tubing, the length of the predrying zone and the temperature of the air are adjusted to one another in such a manner that the moisture of the predried cellulose tubing at the exit from the predrying zone is about 40 to about 60% of the moisture of the wet cellulose tubing.

11. The method as claimed in claim 1, wherein the predried cellulose tubing is dried in the inflated state between two pinch-roll pairs by hot air to a final moisture of up to about 10% of the moisture of the wet cellulose tubing.

12. A device for producing a seamless edible cellulose tubing (2) made of underivatized cellulose which is extruded from an annular die (3) and introduced via an air gap into a water bath (4), is turned round in this and conducted out, conducted via a conveyor belt (1) through a first and second washing section (9, 11) into a plasticizing section (12), wherein the cellulose tubing (2) is transportable from the plasticizing section (12) into a predryer (13) which is provided upstream of a main dryer (19), and the predryer (13) is arranged vertically or horizontally.

13. The device as claimed in claim 12, wherein the predryer (13) has a length of up to about 12 m.

14. The device as claimed in claim 13, wherein, close to an exit orifice (23) of the predryer (13), there is arranged a guide roll (14) round which the cellulose tubing (2) runs after passing through the predryer (13) and, turned round through 180°, passes the predryer (13) a further time and leaves via an exit orifice (24).

15. The device as claimed in claim 14, wherein the cellulose tubing (2), after exit from the predryer (13), is conducted between a roll pair (15) and is turned round one of the rolls of the roll pair (15) in the direction of the main dryer (19).

16. The device as claimed in claim 13, wherein, in the predryer (13), heated air can be blown into the laid-flat cellulose tubing (2).

17. The device as claimed in claim 16, wherein the air which is blown in is heated to a temperature up to about 130° C.

18. The device as claimed in claim 15, wherein an impregnation can be introduced into the interior of the cellulose tubing (2) before its entry into the main dryer (19).

19. The device as claimed in claim 12, wherein two pinch-roll pairs (21, 22) are arranged in the main dryer (19), and the laid-flat cellulose tubing (2) can be inflated between the two pinch-roll pairs (21, 22) by heated air to form a tubular cellulose tubing (20).

20. The device as claimed in claim 19, wherein the tubular cellulose tubing (20) can be dried in the inflated state to its final moisture of up to about 10% of the moisture of the wet cellulose tubing (2) and can be shrunk to its final caliber.

21. The device as claimed in claim 18, wherein the interior of the cellulose tubing (2) is impregnated with an aqueous impregnation solution having about 2% by weight of a distearyl diketene.
